(19) United States
(12) Patent Application Publication
(10) Pub. No.: US 2014/0032854 A1
(43) Pub. Date: Jan. 30, 2014

(54) Coherence Management Using a Coherent Domain Table

(71) Applicant: Futurewei Technologies, Inc., Plano, TX (US)

(72) Inventors: Iulin Lih, San Jose, CA (US); Chenghong He, Shenzhen (CN); Hongbo Shi, Xian (CN); Naxin Zhang, Singapore (SG)

(73) Assignee: Futurewei Technologies, Inc., Plano, TX (US)

(21) Appl. No.: 13/948,632

(22) Filed: Jul. 23, 2013

Related U.S. Application Data
(60) Provisional application No. 61/677,293, filed on Jul. 30, 2012.

(51) Int. Cl. G06F 12/08

(52) U.S. Cl. CPC G06F 12/0815
USPC 711/141

(57) ABSTRACT

A computer program product comprising computer executable instructions stored on a non-transitory medium that when executed by a processor cause the processor to perform the following: assign a first, second, third, and fourth coherence domain address to a cache data, wherein the first and second address provides the boundary for a first coherence domain, and wherein the third and fourth address provides the boundary for a second coherence domain, inform a first resource about the first coherence domain prior to the first resource executing a first task, and inform a second resource about the second coherence domain prior to the second resource executing a second task.

### CROSS-REFERENCE TO RELATED APPLICATION

The present application claims priority to U.S. Provisional Patent Application No. 61/677,293, filed Jul. 30, 2012 by Yolin Lih, et al., titled “Coherence Domain,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Effective cache management is an important aspect of future computer architecture as multicore and other multitasking systems grow in popularity. A cache may store recently used data to improve effective memory transfer rates to thereby improve system performance. The cache may be implemented by memory devices having speeds comparable to the speed of the processor. Because two or more copies of a particular piece of data can exist in more than one storage location within a cache-based computer system, coherency among the data is necessary. In order to perform parallel data processing, various methods may be used to maintain cache coherence and synchronize data operations by components, e.g., reading/writing to a shared file. Some systems may manage cache coherency using a plurality of caches wherein each cache is tied to a particular processing core of a multicore system, while other systems may use a shared cache. However, maintaining independent caches may utilize unnecessary bandwidth and may reduce processing speeds. Additionally, certain programs may require sequenced or ordered access to the data stored in memory by multiple processors and/or resources. Consequently, a need exists for a method of cache coherence which reduces bandwidth requirements and/or permits sequenced or ordered access to the data stored in memory.

### SUMMARY

In one embodiment, the disclosure includes a computer program product comprising computer executable instructions stored on a non-transitory medium that when executed by a processor cause the processor to perform the following: assign a first, second, third, and fourth coherence domain address to a cache data, wherein the first and second address provides the boundary for a first coherence domain, and wherein the third and fourth address provides the boundary for a second coherence domain, inform a first resource about the first coherence domain prior to the first resource executing a first task, and inform a second resource about the second coherence domain prior to the second resource executing a second task.

In another embodiment, the disclosure includes an apparatus for management of coherent domains, comprising a memory, a processor coupled to the memory, wherein the memory contains instructions that when executed by the processor cause the apparatus to perform the following: subdivide a cache data, wherein subdividing comprises mapping a plurality of coherence domains to the cache data, and wherein each coherence domain comprises at least one address range, assign a first coherence domain to a first resource, and assign a second coherence domain to a second resource, wherein the first and second coherence domains are different, and populate a coherent domain table using information identifying the first coherent domain, the second coherent domain, the first resource, and the second resource.

In yet another embodiment, the disclosure includes a method of managing coherent domains, comprising assigning, in a coherent domain table, a first coherence domain to a first resource, wherein the first coherence domain comprises a first address range, and where the first address range points a first portion of a cache data, assigning, in the coherent domain table, a second coherence domain to a second resource, wherein the second coherence domain comprises a second address range, and where the second address range points a second portion of the cache data, providing the first coherence domain to a first resource, providing the second coherence domain to a second resource, receiving indication that the first resource has completed a first task, receiving indication that the second resource has completed a second task, and modifying, in the coherent domain table, the coherent domain table entries associated with the first address range and the second address range for the first coherence domain and second coherence domain.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a multicore processor chip.

FIG. 2 is a coherent domain table for an example embodiment of coherence management using a coherence domain table.

FIG. 3 is a coherent domain table for another example embodiment of coherence management using a coherence domain table

FIG. 4 is a flowchart showing an example embodiment of a coherence domain management process for a system utilizing a cache coherence domain model for cache coherence management.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The disclosure includes using a series of address ranges (or pointers thereto) to subdivide, partition, or otherwise segregate a memory object into a plurality of coherent domains. Coherent domains may be used to ensure cache coherence between multiple processors and/or to sequence processes, tasks, etc. By providing resources with smaller portions of shared data, e.g., providing only certain portions of thread lines, the amount of spreading can be reduced as compared to conventional cache coherence models. Using coherent domains may result in coherent messages being distributed only within a specific coherent domain. Such data localization may reduce resulting message traffic in the coherent domain. The use of a coherent domain may result in improved performance (e.g., due to reduced data traffic and latency), power use (e.g., reduced traffic may reduce power requirements), and cost (e.g., reduced due to lower bandwidth requirements).

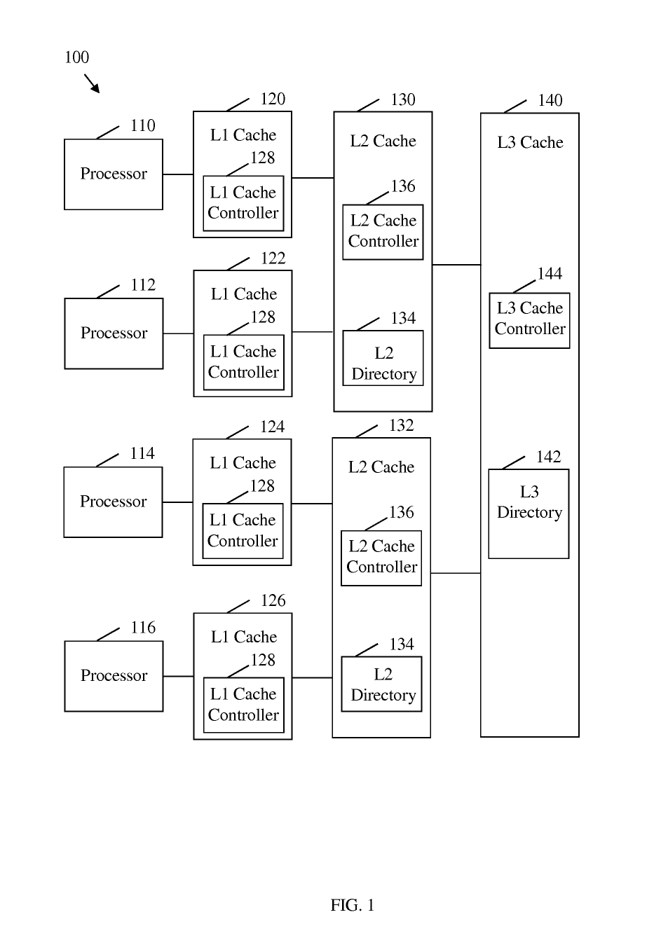

FIG. 1 is a schematic diagram of a multicore processor chip 100. The multi-core processor chip 100 may be implemented as a single integrated circuit die or as a single chip package having multiple dies, as known to one of skill in the art. The multi-core processor chip 100 may comprise multiple processors 110-116 (e.g., cores) that may operate jointly or independently to substantially simultaneously perform certain functions, access and execute routines, etc. While four processors are shown in FIG. 1, those of skill in the art will understand that more or fewer processors may be included in alternate suitable architectures. As shown in FIG. 1, each processor 110-116 may be associated with a corresponding primary or level 1 (L1) cache 120-126. Each L1 cache 120-126 may comprise a L1 cache controller 128. The L1 caches 120-126 may communicate with secondary or level 2 (L2) caches 130 and 132. The L2 caches 130 and 132 may comprise more storage capacity than the L1 caches 120 and may be shared by more than one L1 cache 120-126. Each L2 cache 130 and 132 may comprise a directory 134 and/or a L2 cache controller 136. The directory 134 may dynamically track the sharers of individual cache lines to enforce coherence, e.g., by maintaining cache block sharing information on a per node basis. The L2 cache controller 136 may perform certain other functions, e.g., generating the clocking for the cache, watching the address and data to update the local copy of a memory location when a second apparatus modifies the main memory or higher level cache copy, etc. The L2 caches 130 and 132 may communicate with a tertiary or level 3 (L3) cache 140. The L3 caches 140 may comprise more storage capacity than the L2 caches 130 and 132, and may be shared by more than one L2 cache 130 and 132. The L3 cache 140 may comprise a directory 142 and/or a L3 cache controller 144, which may perform for the L3 cache 140 substantially the same function as the directory 134 and/or L2 cache controller 136. The various components of multicore processor chip 100 may be communicably coupled in the manner shown. While the various caches are depicted as multiple and/or singular, the depiction is not limiting and those of skill in the art will understand that shared caches may be suitably employed in some applications and separate or independent caches suitably employed in others. Similarly, various kinds of caches, e.g., an instruction cache (i-cache), data cache (d-cache), etc., may be suitably employed depending on the needs of the architecture. Further, the various caches may be designed or implemented as required by the needs at hand, e.g., as unified or integrated caches or as caches separating the data from the instructions. Although not illustrated in FIG. 1, the architecture may also include other components, e.g., an Input/Output (I/O) Hub to participate or witness transactions on behalf of I/O devices.

Typically, processors 110-116 may receive instructions and data from a read-only memory (ROM), a random access memory (RAM), and/or other storage device (collectively, “main memory”). In order to reduce the transfer time and increase speed of access to the data stored in main memory, the multicore processor chip 100 may comprise one or more caches, e.g., L1 caches 120-126, L2 caches 130 and 132, and L3 cache 140, to provide temporary data storage, where active blocks of code or data, e.g., program data or microprocessor instructions, may be temporarily stored. The caches may contain copies of data stored in main memory, and changes to cached data must be reflected in main memory. The multicore processor chip 100 may manage cache coherence by allocating a separate thread of program execution, or task, to each processor 110-116. Each thread may be allocated exclusive memory, to which it may read and write without concern for the state of memory allocated to any other thread. However, related threads may share some data, and accordingly may each be allocated one or more common pages having a shared attribute. Updates to shared memory must be visible to all of the processors sharing it, raising a cache coherency issue. Various coherence models may be used to solve the cache coherence problem.

Two types of coherence models are snooping and directory-based coherence. Snooping may be understood as the process wherein individual caches monitor address lines for accesses to cached memory locations. When a write operation is observed to a location that contains a cache copy, e.g., L2 cache 130, the cache controller 136 may invalidate its own copy of the snooped memory location. A snoop filter implemented at the cache controller 136 may reduce the snooping traffic by maintaining a plurality of entries, each representing a cache line that may be owned by one or more nodes, e.g., L1 cache 120 and L1 cache 122. When replacement of one of the entries is required, the snoop filter may select an entry for replacement wherein the entry represents the cache line or lines owned by the fewest nodes, as determined from a presence vector in each of the entries. A temporal or other type of algorithm may be used to refine the selection if more than one cache line is owned by the fewest number of nodes.

Directory-based coherence may refer to a directory-based system wherein a common directory, e.g., L3 directory 142, dynamically maintains the coherence between caches, e.g., L2 caches 130 and 132, along with the data being shared. The directory may act as a filter through which the processor, e.g., processor 110, must ask permission to load an entry from the primary memory to its cache, e.g., L1 cache 120. When a maintained data entry, e.g., a data entry on L1 cache 120, is changed, the directory, e.g., L3 directory 142, may update or invalidate the other caches, e.g., L1 caches 122-126 and L2 caches 130 and 132, with that entry.

Both snooping and directory-based coherence each have benefits and drawbacks. Snooping protocols tend to be faster, provided enough bandwidth is available, since all transactions comprise a request/response seen by all processors. One drawback is that snooping is not scalable. Every request must be broadcast to all nodes in a system, and as the system grows the size of the logical and/or physical bus and the bandwidth needed must grow as well. Directories, on the other hand, tend to have longer latencies, e.g., due to a three-hop request/forward/respond sequence, but may use much less bandwidth since messages are point to point and not broadcast. For this reason, many larger systems, e.g., systems with greater than 64 processors, may use this type of cache coherence.

Alternately, barrier constructs may be implemented to order the parallel data processing. Barrier constructs may prevent certain transactions from proceeding until related transactions have been completed. Barriers may comprise waiting and/or throttling commands and may be used for synchronization and ordering, e.g., among transactions and processors. Barriers may hold certain parts of the hardware in certain conditions for a limited duration, e.g., until certain conditions are met.

While the use of barriers may be advantageous for synchronizing data operations, the use of barriers may be over-conservative and imprecise. A barrier may hold hardware in waiting conditions for unnecessary durations, which may result in unnecessary waste, e.g., in terms of system performance and cost. For example, a system may require that a barrier be issued only after all pre-barrier transactions are completed, and it may further require that post-barrier transactions be issued only after the barrier is removed. In such cases, barrier spreading range may be tightly limited at the expense of parallelism. In another example, a system may issue a barrier before the completion of pre-barrier transactions, and may further forward the barrier widely, depending on the network topology and the location of the global observation points. Consequently, a need exists to more precisely identify and utilize coherence domains.

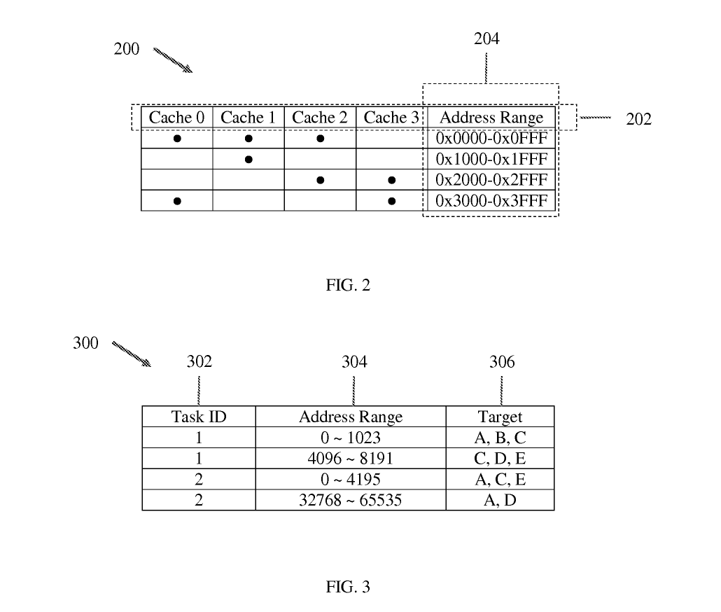

FIG. 2 is a coherent domain table 200 for an example embodiment of coherence management using a coherence domain table. A cache coherence domain may comprise one or more subdivided segments of a memory, e.g., an L3 cache 140 memory, using one or more address ranges to isolate at least a portion of a thread, program, task, instruction, or other data. Such data objects may be divided into threads and the divided portions may be allocated to resources. Cache coherence domains may subdivide these threads in a task-dependent way or a data-dependent way and provide the subdivided data to the resources. For example, a thread may be divided into coherence domains in a way comprising certain barrier model process sequencing functionality, e.g., sequencing a first coherence domain for a first resource before a second cache coherence domain for a second resource. Similarly, a thread may be divided into coherence domains in a way comprising a minimization of shared data, thereby providing a comparatively narrow range of data for which cache coherence needs to be managed. The cache coherence domain(s) may be configurable and may be dynamically altered based on the needs and/or resources of the implementing system, e.g., by modifying the address ranges, by changing the number of address ranges in a coherence domain, etc. In some cases, the mapping of coherence domains occurs prior to the initiation of the related process or task, while in others the mapping of coherence domains occurs concurrently with the related process or task.

Table 200 may be stored at a cache directory, e.g., L3 directory 142. The top row 202 of table 200 contains labels for a plurality of caches, e.g., L1 caches 120-126. The right column 204 contains address ranges subdividing or partitioning a memory location, e.g., on L3 cache 140. Table 200 is populated with a mapping of address ranges and resources, illustrating the coherence domain for each resource. As shown, cache 0 may have a coherence domain comprising the first and fourth address ranges, cache 1 may have a coherence domain comprising the first and second address ranges, cache 2 may have a coherence domain comprising the first and third address ranges, and cache 3 may have a coherence domain comprising the third and fourth address ranges. As shown, coherence domains for various resources may comprise overlapping address ranges. In some embodiments, a plurality of resources may share identically overlapping coherence domains. Once the table 200 has been populated with the coherence domain information for each resource, a cache controller, e.g., L3 cache controller 144, may send a coherence message to the relevant resource, e.g., L1 caches 120-126, comprising coherence domain information, e.g., data, address ranges, process dependencies, peer resources sharing the coherence domain, etc., for the cache data with respect to the relevant resources. Once the resources have been mapped to the coherence domains and the relevant data transferred, the coherent domain table 200 may function similarly to a simple snoop filter, e.g., by mapping and/or tracking cache data-resource assignments and selectively generating snoop operations, e.g., broadcasting snoop requests, etc., to particular cache memory when the requested cache line is present in the particular cache memory. Similar to a conventional barrier model, the coherence domain may utilize precisely identified memory locations to order or sequence processes, tasks, or transactions. If information is received at table 200 that the coherence domain (or a portion thereof) is no longer required, e.g., because the related process or task is completed, the relevant entry/entries in the table 200 may be deleted and the section(s) of the coherence domain(s) may be released.

FIG. 3 is a coherent domain table 300 for another example embodiment of coherence management using a coherence domain table. Table 300 may be useful in implementing coherence management for a software managed snoop filter wherein the software lists the possible snoop targets according to the task identification (ID) and the address. Once configured by the software, snoop traffic management may be implemented using hardware. Table 300 may be stored at a cache directory, e.g., L3 directory 142. Column 302 comprises a task ID indicating the particular task being executed by a system, e.g., multi-core processor chip 100. Column 304 comprises address ranges needed for the task, e.g., address ranges indicated in column 204. Column 306 indicates one or more cache or memory units A, B, C, D, and E, e.g., the caches of row 202. As shown, task ID 1 may only involve the cache or memory units A, B, and C for the address range 0˜1023, while cache or memory units D and E may be excluded. Similarly, task ID 2 may involve cache or memory units A, C, and E for operations for the address range 0˜4195. As will be understood by those of skill in the art, table 300 may be modified for use with barrier range management, either jointly or using separately dedicated tables, and such embodiments are considered within the scope of the invention.

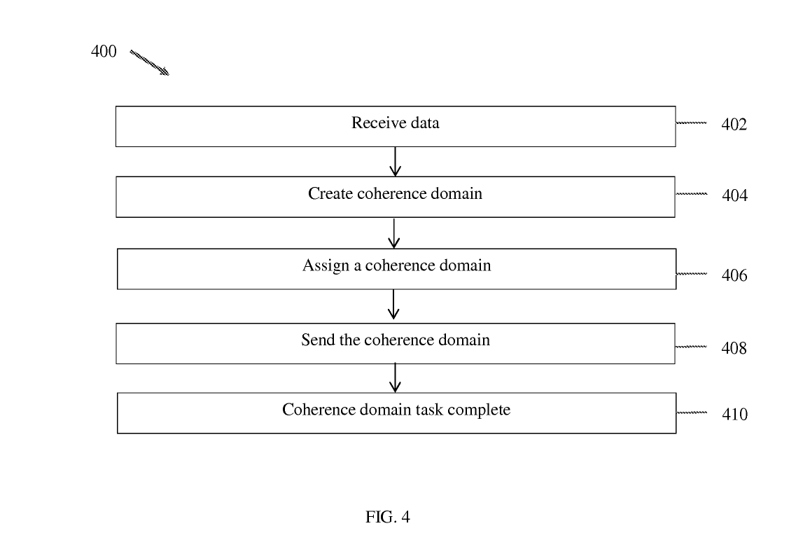

FIG. 4 is a flowchart showing an example embodiment of a coherence domain management process 400 for a system, e.g., multicore processor chip 100, utilizing a cache coherence domain model for cache coherence management. At 402, a cache, e.g., L3 cache 140, may receive data from main memory. At 404, a cache controller, e.g., L3 cache controller 144, may create a coherence domain by partitioning or subdividing the data into two or more segregated address ranges, e.g., using pointers to point to specific memory addresses, which address ranges may or may not be contiguous. In some embodiments, the cache controller may create a plurality of coherence domains for a plurality of tasks and/or a plurality of resources, e.g., to ensure appropriate synchronizing or ordering of tasks. In some embodiments, the coherence domains will comprise at least a portion of the same data, while in other embodiments the coherence domains will be entirely distinct, not containing any of the same data. At 406, each coherence domain may be assigned to a particular resource, e.g., one of processors 110-116. The creation and assignment of coherence domains may be logged in a directory, e.g., L3 directory 142. At 408, the coherence domain may be sent to the associated resource, e.g., the L1 cache associated with the processor. In some embodiments, the data within the cache domain may be sent to the associated resource, while in other embodiments the pointer information may be sent to the associated resource. At 410, the resource may complete the task which required the coherence domain and may send indication that the coherence domain, or a sub-portion thereof, is no longer required. This indication may permit the cache controller to release the coherence domain in its directory, e.g., by deleting the entry associated with the coherence domain. In some embodiments, the coherence domain entry may be modified or reconfigured, e.g., substituting alternate address ranges and/or assigning new values in the relevant entries, rather than deleting the entry.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. All documents described herein are incorporated herein by reference.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A computer program product comprising computer executable instructions stored on a non-transitory medium that when executed by a processor cause the processor to perform the following:
assign a first, second, third, and fourth coherence domain address to a cache data, wherein the first and second addresses provide a boundary for a first coherence domain, and wherein the third and fourth addresses provide the boundary for a second coherence domain;
inform a first resource about the first coherence domain prior to the first resource executing a first task; and
inform a second resource about the second coherence domain prior to the second resource executing a second task.

2. The computer program product of claim 1, wherein the computer executable instructions further cause the processor to:
inform a third resource about the first coherence domain prior to the third resource executing a third task; and
inform a fourth resource about the second coherence domain prior to the fourth resource executing a fourth task.

3. The computer program product of claim 2, wherein the computer executable instructions further cause the processor to:
delete the first and second coherence domain addresses upon completion of the first and third tasks; and
delete the third and fourth coherence domain addresses upon completion of the second and fourth tasks.

4. The computer program product of claim 1, wherein the second and third coherence domain addresses are the same.

5. The computer program product of claim 1, wherein the information contained in the cache data in the first coherence domain comprises at least a portion of the information contained in the cache data in the second coherence domain.

6. The computer program product of claim 1, wherein the information contained in the cache data in the first coherence domain does not comprise any of the information contained in the cache data in the second coherence domain.

7. An apparatus for management of coherent domains, comprising:
a memory;
a processor coupled to the memory, wherein the memory contains instructions that when executed by the processor cause the apparatus to perform the following:
subdivide a cache data, wherein subdividing comprises mapping a plurality of coherence domains to the cache data, and wherein each coherence domain comprises at least one address range;
assign a first coherence domain to a first resource;
assign a second coherence domain to a second resource, wherein the first and second coherence domains are different; and
populate a domain table using information identifying the first coherent domain, the second coherent domain, the first resource, and the second resource.

8. The apparatus of claim 7, wherein the instructions further cause the apparatus to send a first coherence message comprising information about the first coherence domain to the first resource and send a second coherence message comprising information about the second coherence domain to the second resource.

9. The apparatus of claim 8, wherein the instructions further cause the apparatus to send the first coherence message to a first plurality of resources and send the second coherence message to a second plurality of resources.

10. The apparatus of claim 7, wherein the first coherence domain comprises at least a portion of cache data referenced by the second coherence domain.

11. The apparatus of claim 7, wherein the first coherence domain is mapped prior to the initiation of a related process.

12. The apparatus of claim 7, wherein the first coherence domain is deleted after the completion of a related process.

13. The apparatus of claim 7, wherein the domain table is a barrier domain table.

14. The apparatus of claim 7, wherein the first coherence domain and the second coherence domain are accessed by separate processes.

15. A method of managing coherent domains, comprising:
assigning, in a coherent domain table, a first coherence domain to a first resource, wherein the first coherence domain comprises a first address range, and wherein the first address range points to a first portion of cache data;
assigning, in the coherent domain table, a second coherence domain to a second resource, wherein the second coherence domain comprises a second address range, and wherein the second address range points to a second portion of the cache data;
providing the first coherence domain to a first resource;
providing the second coherence domain to a second resource;
receiving an indication that the first resource has completed a first task;
receiving an indication that the second resource has completed a second task; and
modifying, in the coherent domain table, the coherent domain table entries associated with the first address range and the second address range for the first coherence domain and the second coherence domain.

16. The method of claim 15, wherein the first coherence domain comprises at least a portion of the cache data referenced by the second coherence domain range.

17. The method of claim 15, wherein the first coherence domain does not contain any of the cache data referenced by the second coherence domain range.

18. The method of claim 15, wherein modifying the coherent domain table entries comprises deleting the coherent domain table entries associated with the first address range and the second address range for the first coherence domain and second coherence domain.

19. The method of claim 15, wherein modifying comprises assigning new values to the coherent domain table entries associated with the first address range and the second address range for the first coherence domain and the second coherence domain.

20. The method of claim 15, wherein each of the first coherence domain and the second coherence domain comprises a plurality of non-contiguous address ranges.
